(19) United States
(12) Patent Application Publication
(10) Pub. No.: US 2022/0217975 A1
(43) Pub. Date: Jul. 14, 2022

(54) GREEN FORMULATION TO REDUCE VOLATILITY AND LEACHING OF PESTICIDES

(71) Applicants: POLITECNICO DI TORINO, Torino (IT); UNIVERSITA' DEGLI STUDI DI TORINO, Torino (IT)

(72) Inventors: Tiziana Anna Elisabetta TOSCO, Torino (IT); Luca SERPELLA, Torino (IT); Monica GRANETTO, Torino (IT); Carlo BIANCO, Torino (IT); Francesco VIDOTTO, Torino (IT); Silvia FOGLIATTO, Torino (IT)

(73) Assignees: POLITECNICO DI TORINO, Torino (IT); UNIVERSITA' DEGLI STUDI DI TORINO, Torino (IT)

(21) Appl. No.: 17/611,137

(22) PCT Filed: May 11, 2020
(86) PCT No.: PCT/IB2020/054421

§ 371 Date: Nov. 13, 2021

(30) Foreign Application Priority Data
May 15, 2019 (IT) 102019000006852

(51) Int. Cl. A01N 25/26; A01N 25/34

(52) U.S. Cl. CPC A01N 25/26; A01N 37/40; A01N 25/34

(57) ABSTRACT

A pesticide formulation includes an active ingredient, a substrate of a mineral origin and a biopolymer coating, wherein the active ingredient is adsorbed on a surface of the substrate and wherein the biopolymer coating covers the substrate, and the pesticide formulation is an herbicide formulation. A method for a production of the pesticide formulation and a method for a control of weeds by the herbicide formulation are provided. The pesticide formulation is advantageous applications for weeding agricultural areas, pasture areas, uncultivated areas and non-agricultural areas.

### CROSS REFERENCE TO THE RELATED APPLICATIONS

This application is the national stage entry of International Application No. PCT/IB2020/054421, filed on May 11, 2020, which is based upon and claims priority to Italian Patent Application No. 102019000006852 filed on May 15, 2019, the entire contents of which are incorporated herein by reference.

### TECHNICAL FIELD

The present invention refers to the field of pesticide formulations and, in particular, of herbicides.

Specifically, the present invention concerns an environmentally friendly pesticide formulation with reduced levels of volatility and leaching of the compound having pesticide action (hereinafter referred to as “active ingredient”).

More specifically, the present invention concerns an herbicide formulation comprising dicamba, which is an active ingredient having an herbicide action employed for the control of large-leaved weeds, used in various crops such as corn, soybean, cotton, sugarcane, asparagus, etcetera.

The invention also concerns a method for the production of the aforesaid pesticide formulation. More specifically, the invention also concerns an herbicide formulation, the relevant method of production and a method for the control of weeds by means of the aforesaid herbicide formulation.

The invention finds advantageous applications for weeding agricultural areas, pasture areas, uncultivated areas and non-agricultural areas; the invention finds its preferred application in the field of agriculture—of intensive type, on field or in a greenhouse—and especially in the regions where the above-mentioned crops are present, such as for example in Europe, North America, South America and Russia.

### BACKGROUND

The use of herbicides is a usual practice in agriculture, but it has several negative effects linked to the toxicity and to the dispersion in the environment of these substances.

Among herbicides, different products can show very different behaviours.

Some active ingredients having herbicide action of common use that, though being extremely effective, are characterized by a certain persistence and can move along the ground profile moving with the percolating waters, reaching in some cases the groundwaters.

Other active ingredients have high volatility, which can in turn determine the occurrence of secondary drift phenomena and redeposition of the active ingredient outside the crop object of the treatment. The latter phenomenon, besides constituting a potential negative impact on the environment, can cause phytotoxicity phenomena if the active ingredient comes in contact with sensitive crops, besides constituting a potential danger for the operator and the bystanders.

All of these problems, even if in some cases did not lead to the abandonment of the use of such active ingredients, it effectively limits the fields of application, leading on the other hand to employ substances in some cases more toxic and persistent in the environment, but easier to manage.

An example of these problems relates to the case of dicamba, an active ingredient having herbicide action commonly used in agriculture for the control of large-leaved weeds, applied on different naturally tolerant crops (for example corn and sorghum), in meadows and pastures of grasses and uncultivated areas, as well as on some dicotyledons crops made resistant to the molecule through genetic engineering techniques (e.g. soy and cotton, especially widespread in the U.S.A.); dicamba-based formulations and their uses are described, for example, in patents such as US 2012/0142532 A1, US 2018/0255769 A1 and US 2018/0255770 A1.

The dicamba-based formulations are widely used and their employ has been growing in recent years.

The formulation is applied in post-emergence on weeds plants and the herbicide action against the susceptible species is revealed as a result of predominantly leaf absorption, even if a part of the applied product can be absorbed by the root system.

Dicamba is a molecule known for decades (its herbicide action has been studied since 1950 and the first commercial dicamba-based product was registered in the United States in 1967), it is relatively low toxic and it is less persistent in the environment than other active ingredients with similar use. In literature, most of the sources report for dicamba a half-life time ranging between 3 and 150 days depending on environmental conditions, although the most frequently reported values are lower than 20 days.

However, dicamba turns out to be characterized by a high solubility in water and it is therefore easily leached by rains and irrigations, with resulting dispersion in the subsoil; it binds in a limited way to the soil particles (K_{OC}=2 g/mL) and it is relatively volatile (vapour pressure of the dicamba active ingredient equal to 2.6·10⁻⁸ atm), even if the effective volatilization depends on the specific commercial formulation.

The high solubility and volatility of dicamba involve, at present, a series of problems only in part solved by the commercial formulations on the market today:
possible long distance transport due to volatilization during and after application (vapour drift, or secondary drift), with possible damages to crops adjacent to those treated;
biological activity (herbicide efficacy) in some cases lower than its potentialities due to evaporative losses.

A further motivation of the present invention is linked to the possible medium- and long-term evolutions of the European market of the plant protection products.

In particular, a partial competitor of dicamba turns out to be, in many applications, the glyphosate; glyphosate-based formulations and their uses are described, for example, by Richmond M. E. (2018). Glyphosate: A review of its global use, environmental impact, and potential health effects on humans and other species. In: Journal of Environmental Studies and Sciences 8(4), pages 416-434.

For the glyphosate, in December 2017, the EU renewed the use authorization in the European Union for additional five years, i.e. up to the 2022; the authorization will be reevaluated by a glyphosate assessment team (AGG), the outcome of which will be examined by the EFSA (European Food Safety Authority), the competent European authority, in 2021. It is to be noted however that, internationally, some studies have recently appeared that suggest a glyphosate toxicity greater than what previously assessed and that, if confirmed, could lead to a future revision of the EFSA's opinion.

On the other hand, dicamba has been relaunched at international level, in particular in the United States, in alternative weeding programs to the sole use of glyphosate, especially for soybean cultivation.

However, in such situation the importance of the above-discussed problems has risen, and in particular the possible damages caused by the molecule to the crops surrounding the application area.

Therefore, the need to identify alternatives to the existing formulations currently on the market is particularly felt.

Different formulations were proposed to make the active ingredient more effective and environmentally friendly.

The uncontrolled dispersion of herbicides in the environment and the undesired effects associated thereto as previously underlined (including, potential risks due to volatilization, leaching following rains and/or irrigations with consequent loss of product and damage to surrounding crops) are relatively frequent for several commercial formulations and concern, in particular, the active ingredients characterized by medium or high solubility and volatility.

For example, the herbicide formulation “Imprelis”, an aminocyclopyrachlor-based product, marketed by DuPont, has been removed from the US market in August 2011 (see https://blog.restek.com/?p=3307) since it raised concerns about a possible link between its use and the negative impact on conifers and shrubs near the treated areas due to volatilization phenomena.

Another example is the dicamba-based herbicide formulation “Banvel” by Syngenta, for which a possible risk of damaging the surrounding crops has been highlighted, so as to require specific precautions during the application.

Finally, another commercial dicamba-based formulation called “XtendiMax”, recently introduced on the US market by Monsanto, has brought cases of serious damages to soybean crops, prompting the authorities of some States to prohibit the use of dicamba-based products on their territories.

As specifically regards the dicamba active ingredient, to date the dosage recommended by the manufacturers for the different commercial formulations takes into account the dispersions by volatilization and the leaching and, therefore, the amount applied is normally higher than that theoretically sufficient to obtain the desired herbicide effect; consequently, a waste in economic terms and a potential greater impact on the quality of air, soil and groundwater result.

As already mentioned, in recent years research has been mainly addressed to the definition of new formulations that reduce the dispersion in the environment, predominantly focusing on the volatilization and, in parallel, trying to increase the product effectiveness.

Different commercial products currently exist aiming at reducing the dicamba volatility (for example, Mondak 21S by Syngenta); most of these commercial products use excipients, adjuvants or other chemical compounds dosed in low percentages inside the herbicide aqueous solutions, whose purpose is to partially reduce the volatility and to increase the leaf contact (for example employing wetting oils).

In some cases (for example, in patents US 2012/0142532 A1 and U.S. Pat. No. 9,743,664 B2) in order to reduce the volatilization the use of the active ingredient in the form of salt of dicamba—rather than in the form of benzoic acid—is preferred and/or with the addition of emulsified esters, ammonium salts, metal salts or additives; however, these solutions have proved to be little effective in improving the environmental impact of dicamba, and only partially effective in reducing volatility.

Other applications (for example, the U.S. Pat. No. 7,774,978 B2) provide for directly treating the crop seeds with the herbicide and subsequently applying a polymer coating that, however, let the active ingredient migrate towards outside, so as to perform the herbicide effect at radical level in the immediate vicinity of the seed of the cultivated plant.

As more generally regards the plant protection products, an approach followed in recent years for several active ingredients is to develop formulations containing solid supports (micrometric particles or, but less frequently, nanometric particles) incorporating the active ingredient in various ways such as, for example, the formulations reported in the article by Kah M., Beulke S., Tiede K., and Hofmann T. (2013). Nanopesticides: State of Knowledge, Environmental Fate, and Exposure Modeling. In: Critical Reviews in Environmental Science and Technology 43 (16), pages 1823-1867 that reduce problems of various kinds such as the low solubility or stability of the active ingredients; among these, the most widely used formulations provide the use of supports made of a biodegradable polymers matrix in which the herbicide is incorporated (for example, the Syngenta patent US 2014/0221206 A1).

According to the aforesaid solutions, following the application the support undergoes a degradation process and the active ingredient is then released, moreover allowing to exploit this mechanism for controlling the release speed of the compound, which depends on the degradation speed of the polymer.

This approach is applied with various purposes: to reduce the volatilization of medium and high volatility compounds; to facilitate the dispersion in water and then the application on field of hydrophobic and slightly soluble compounds; to protect compounds that, if not protected by a support, are subject to a too rapid degradation. The use of supports to reduce the mobility in the subsoil of very soluble compounds is reported, for example, in El-Nahhal Y., Undabeytia T., Polubesova T., Golda Mishael Y., Nir S., Rubin B. (2001). Organo-clay formulations of pesticides: reduced leaching and photodegradation. In: Applied Clay Science 18(5-6), pages 309-326 and in Fernández-Pérez M., Garrido-Herrera F. J., González-Pradas E. (2011). Alginate and lignin-based formulations to control pesticides leaching in a calcareous soil. In. Journal of Hazardous Materials 190 (1-3), pages 794-801.

As regards the dispersion into air of the volatile active ingredients (“vapour drift” or drift), today's formulations usually use adjuvant substances, called anti-drift, to improve the adhesion of the formulation with the leaf (an example is represented by the canola oil, such as for example in the commercial adjuvants “Codacide” and “Zarado” by Microcide Ltd).

Nowadays the formulations using supports often incorporate two or more active ingredients (as described in the Syngenta patent US 2014/0221206 A1) in order to achieve the applicative advantages such as reducing the application frequency, obtaining a complete system in a single solution or overcoming the incompatibility problems between two or more active ingredients, which could create antagonism phenomena, with an overall reduction of efficacy for one or more of the active ingredients in a mixture.

On the other hand, in the United States the effects linked to the dicamba volatilization phenomena have raised several toxicological problems and concerns: these problems and concerns need to be remedied too.

In this sense, several researches have been carried out as to the use of solid substrates for reducing the volatility of this particular active ingredient. Among these, two formulations (as reported in patents US 2018/0255769 and US 2018/0255770) containing at least one auxin herbicide (dicamba) and at least one derivative of cationic and non-ionic polysaccharide, respectively, can be mentioned. These latters, however, are used as adjuvants in low percentages (0.65%) with the limit that release can not be modulated.

Other formulations without a substrate (as reported for example in U.S. Pat. No. 9,743,664 B2—Monsanto) are known, which provide to realise herbicide formulations with low volatility and anti-drift containing at least one auxin herbicide (dicamba) and at least one monocarboxylic acid with variable ratio. In this formulation, dicamba can also be used in the form of salt. The presence of multiple components in the formulation makes the search for the best combination more difficult.

On the other hand, other formulations provide to use an adsorbent substrate containing the herbicide that is coated with an electrostatic coating on which, in turn, a second herbicide or other pesticide (as reported in patent CA 2242781 A1) can be adsorbed. In general, this type of formulation is however more suitable as an insecticide, since the coating allows the formulation to hook the insects cuticle. Often the substrate undergoes a chemical pretreatment to increase its adsorption capacity.

All the problems listed so far remain unsolved up to now and, therefore, the need of having available formulations having pesticide, and in particular herbicide, action is felt, for active ingredients that, despite possess critical properties such as medium-high solubility and not negligible volatility, allow their use minimizing the risks for both the humans and the environment.

The need of having available, in general, plant protection products safely applicable on field in solution/suspension/aqueous dispersion, with increasing benefits as much as the active ingredient is soluble and/or volatile, is also felt.

A formulation capable of controlling the solubility and volatility of the active ingredient would meet the needs of several applications in the agricultural field.

The present invention, which concerns such a formulation, intends to answer to the aforesaid needs, and specifically the present invention intends to solve the technical problem of the dosage of active ingredients having pesticide or herbicide action characterized by high solubility and volatility.

In particular, the present invention aims at solving the technical problem of the dosage of active ingredients having pesticide or herbicide action characterized by high solubility and volatility. Moreover, the present invention intends to solve the technical problem of reducing the high solubility of the active ingredient that, if present for the specific compound taken into consideration, makes it easily leachable by rains and irrigations, with consequent dispersion in the subsoil.

Moreover, the present invention intends to solve the technical problem of reducing the high volatility of the active ingredient that, if present for the specific compound taken into consideration, can represent a risk for the operator's health and lead to the dispersion in air of significant amounts of the active ingredient itself, which, on one side, does not perform the expected action on the area on which it has been applied and, on the other side, can have a negative impact on adjacent crops and more generally on the vegetation and fauna present in the areas immediately surrounding that of application.

In summary, therefore, up to the present time, as far as the Applicants know, solutions allowing to control in a sufficiently effective way the solubility and the volatility of the pesticide/herbicide active ingredient are not known.

Therefore the Applicants, with the formulation according to the present invention, intend to remedy this lack.

### SUMMARY

It is an object of the present invention to overcome the drawbacks of the known art linked to the use of formulations having pesticide, in particular herbicide, action comprising an active ingredient with high solubility and volatility.

Furthermore, it is an object of the present invention to anticipate the possible regulatory restrictions relevant to the use of pesticides and herbicides.

These objects are achieved with the formulation according to the present invention that, advantageously and thanks to the adsorption of the active ingredient on a nanosubstrate of mineral origin, not chemically pretreated, covered with a degradable biopolymer based coating, allows to control the solubility and the volatility of the pesticide/herbicide active ingredient. More precisely, the present invention intends to overcome some technical and environmental problems linked to the use of active ingredients having pesticide/herbicide action characterized by high solubility and volatility (for example, of the dicamba herbicide) through the use of nanosubstrates of natural origin (for example, clays), in order to reduce the dispersion in the environment of the active ingredient and consequently the current employ doses, without reducing the technical effectiveness thereof.

The present invention proposes a nanoformulation aimed at reducing the volatilization of the active ingredient, so as to allow its lower dispersion in air and dangerousness for the operator, as well as to make the product, once applied, less easily leached, thereby contributing to a smaller dispersion in subsoil; it is worthy to underline that the direct effect of the dispersions reduction in the environment is the ability to significantly reduce the overall employ doses of active ingredient, currently affected by the dispersion losses in the ambient.

The clay particles are generally less mobile in soil and subsoil than the active ingredient dissolved in water, while both the fact that the active ingredient is adsorbed on the clay particles and the biopolymer coating guarantee a lower volatility of the active ingredient itself compared to the active ingredient dispersed in aqueous phase; in addition, the presence of the coating contributes to delay the release of the active ingredient.

Specifically, the aforesaid and other objects and advantages of the invention, as will become apparent from the following description, are achieved with a formulation according to claim 1. Other embodiments and variations of the formulation according to the present invention form the object of the dependent claims.

It is understood that all the appended claims form an integral part of the present description and that each of the technical features claimed therein is possibly independent and usable autonomously with respect to the other aspects of the invention.

It will be immediately apparent that innumerable modifications (for example relating to shape, dimensions, arrangements and parts with equivalent functionalities) can be made to what described without departing from the scope of the invention as claimed in the appended claims. For example, as already mentioned, the preferred embodiment of the present invention provides the employ of dicamba, herbicide active ingredient that has high volatility and solubility, but the invention can be extended to other active ingredients and provides the incorporation of other herbicides and plant protection active ingredients, such as insecticides, acaricides, fungicides and the like, as well as fertilizers that have the same problem (high solubility or high volatility or both); in this way, the invention can be extended to manage a greater number of biotic and abiotic adverse events and it can represent a valuable aid in cultivating and increasing vegetable production.

Given what above explained, the following advantages of the formulation of the present invention compared to the formulations available today are highlighted:
environmental and health advantage: as will be explained in detail in the following description in the comments section to the experimental data, the laboratory tests carried out on the formulation of the present invention show a volatility reduction of 30% and a decrease up to 95% of the mobility in a porous medium with respect to the commercially available formulations; this implies a lower dispersion risk in the environment of the herbicide ingredient and the possibility to reduce the doses with respect to those recommended for the existing commercial products;
technical advantage: it is possible to modulate the amount of released herbicide active ingredient and the release speed by varying the thickness of the coating applied on the clay particles of the substrate, for example by using different polymers characterized by different lengths of the polymer chains; similar effects can be obtained also by modifying the type of clay and/or by using other materials with similar behaviour, for example zeolites; the change of the type of clay and/or coating allows to use the formulation not only for the controlled release of dicamba (which is the preferred embodiment of the present invention), but more generally for other compounds with similar problems; the choice among different clays and/or biopolymers of natural origin is substantially irrelevant from an economic point of view, since these materials have a negligible cost compared to the cost of the active ingredient;
economic advantage: the formulation of the present invention allows to reduce the employ doses for each hectare thanks to the reduction of unwanted dispersions;
technical-economic advantages: the formulation of the present invention provides a production method that is very simple (batch loading of the clay particles at ambient, or at least not controlled, pressure and temperature, under mechanical stirring conditions), rapid (it is possible to obtain the finished product, ready to be used, in just over two hours) and economic (the necessary materials—clay nanoparticles and biopolymers—have a very low cost) and, consequently, for the same production of the nanoherbicide according to the present invention and of any other commercial formulation, there is a reduction in the energy demand; moreover, the raw materials used for obtaining the formulation according to the present invention are, in number, much smaller than those of the commercial competitors (in fact, in the formulation according to the present invention stabilizers, crosslinking agents (“crosslinker”), agents to perform a replacement of a surface functional group (“grafting”) are not present and, consequently, there is a saving in economic terms and also in terms of environmental impact.

Further advantageous features will appear more evident from the following description of preferred but not exclusive embodiments, given by way of pure and non-limiting example.

### BRIEF DESCRIPTION OF THE DRAWINGS

The present invention will be described hereinbelow by means of some preferred embodiments, given by way of non-limiting example, with reference to the attached drawings. These drawings illustrate different aspects and examples of the present invention and, where appropriate, similar structures, components, materials and or elements in different figures are denoted by similar reference numbers.

FIG. 1 is a schematic representation of the herbicide formulation (1) according to the present invention, comprising the active ingredient (2), the substrate of mineral origin (3) and the biopolymer coating (4);

FIG. 2 is a graph illustrating the variation of the percentage of herbicide adsorbed on the substrate compared to the amount initially inserted in solution during the adsorption phase (Encapsulation Efficiency, EE %) and the percentage of herbicide adsorbed on the substrate compared to the amount of support, in grams, on which the adsorption takes place (Loading Capacity, LC %) depending on the initial concentration of the active ingredient (dicamba) in the solution used during the loading phase on the substrate (montmorillonite K10) according to the present invention;

FIG. 3 is a graph illustrating the results of the release tests, showing the percentage of active ingredient (dicamba) that remained adsorbed on the substrate (montmorillonite K10) in the six hours following dilution; the amount is expressed as the percentage of adsorbed mass with respect to the initial mass (g/g) according to the present invention;

FIG. 4 is a graph illustrating a comparison among infrared spectra of the active ingredient (dicamba), of the substrate (montmorillonite K10) and of the herbicide formulation (dicamba adsorbed on montmorillonite K10) according to the present invention; it is to be highlighted the occurred formation of a hydrogen bond between the substrate and the active ingredient, as well as the replication of the typical wave modes of the active ingredient on the spectrum of the herbicide formulation;

FIG. 5 is a graph illustrating the results of transport tests in column for the sole active ingredient (dicamba), for the herbicide formulation according to the present invention (dicamba adsorbed on montmorillonite K10 with biopolymer coating) and for a commercial formulation of the same active ingredient (specifically the formulation called Mondak 21S); the term injected PV means the number of pore volume (solution volume corresponding to the column pore volume, a parameter that represents a time scale) injected in the column starting from the time t=0, being C the concentration exiting the column at time t and being C₀ the concentration of the solution injected into the column;

FIG. 6 is a graph illustrating the herbicide loss by volatilization over 4 days for the sole active ingredient (dicamba) dispersed in water, for a commercial formulation (Mondak 21S) and for the herbicide formulation according to the present invention (dicamba adsorbed on montmorillonite K10 with and without biopolymer coating). The two formulations with and without biopolymer coating are overlapped due to the negligible herbicide loss;

FIG. 7 is a flowchart of the method for producing the herbicide formulation according to the present invention.

### DETAILED DESCRIPTION OF THE EMBODIMENTS

While the invention is susceptible of various modifications and alternative constructions, some preferred embodiments are shown in the drawings and will be described in detail hereinbelow. It is to be understood, however, that there is no intention to limit the invention to the specific illustrated embodiments, but, on the contrary, the invention is intended to cover all modifications, alternative constructions and equivalents falling within the scope of the invention as defined in the claims.

In the following description, therefore, the use of “for example”, “etcetera”, “or” means non-exclusive alternatives without limitation, unless otherwise indicated; the use of “also” means “including, but not limited to” unless otherwise indicated; the use of “includes/comprises” means “including/comprising, but not limited to” unless otherwise indicated.

The formulation of the present invention is based on the innovative concept of combining in a single system an active ingredient (i.e. dicamba in the preferred embodiment of the invention, hereinafter illustrated in detail), a substrate of mineral origin (i.e. a clay in the preferred embodiment of the invention, hereinafter illustrated in detail) and a biopolymer coating (i.e. a degradable biopolymer in the preferred embodiment of the invention, hereinafter illustrated in detail).

The Inventors have in fact surprisingly observed and unexpectedly discovered that such a formulation is able to control the release mode and/or the kinetics of the active ingredient, specifically in relation to the solubility and volatility properties of the latter.

The active ingredient of the preferred embodiment of the present invention is dicamba, an herbicide widely used in agriculture for the control of large-leaved weeds; it is less toxic and less persistent in the environment than other active ingredients with similar use, but it suffers from high solubility (and it is therefore easily leachable by rains and irrigations, with consequent dispersion in the subsoil), volatility (complex application on field and risk for the operator's health) and mobility.

To solve these problems the present invention is based on the use of clay nanoparticles (preferably montmorillonite), onto which the active ingredient is adsorbed (as mentioned above, preferably dicamba) protected by a polymeric coating (preferably biodegradable polysaccharides, such as guar gum and carboxymethylcellulose).

The production method takes place in aqueous phase, under conditions of ambient pressure and temperature, by adsorption of the active ingredient on the substrate particles, the coating is then realised and the particles are then concentrated in order to be stored.

For the application on field—which can occur employing the sprayers commonly used to carry out the treatments—a dilution in water is preferably provided.

It is evident how the employed raw materials (clay, biopolymer) have a practically zero environmental impact, which makes the invention “eco-friendly” both from the production point of view and the application one, and therefore preferable to the competitor products.

In the present description, the term “active ingredient” means the chemical compound that performs the pesticide action.

In the present description, the term “substrate” means the material (of micro or nanometric dimensions) on which the active ingredient will be adsorbed (but without the latter); in particular, the term “substrate of mineral origin” means a material of micro or nanometric dimensions whose main component consists of minerals mainly belonging to the group of phyllosilicates. The term “active substrate” means the assembly of substrate and active ingredient adsorbed thereon.

In the present description, the term “coating” means the covering layer adsorbed on the substrate on which the active ingredient has, in turn, been adsorbed; in particular, the term “biopolymer coating” means the particular case in which the coating is formed, in prevalent percentages, by a biopolymer.

In the present description, the term “formulation” means the assembly of active ingredient and any additional ingredients, whether they are substrates, adjuvant additives or other elements, together forming a commercial or potentially marketable product.

In the present description, the term “Encapsulation Efficiency, EE %” means the percentage obtained by comparing the amount of active ingredient adsorbed on the support, W_{ads} [g], and the amount of active ingredient inserted in solution during the adsorption phase, W₀ [g], necessary to obtain the initial solution at concentration C₀.

In the present description, the term “Loading Capacity, LC %” means the percentage obtained by comparing the amount of active ingredient adsorbed on the support, W_{ads} [g], and the amount of substrate inserted in solution during the adsorption phase, W_{sub} [g], necessary to obtain the formulation.

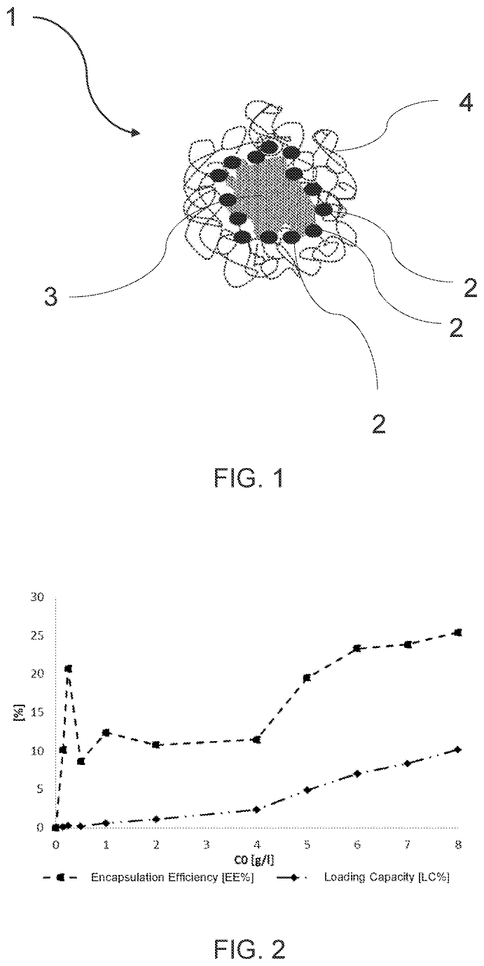

With reference to FIG. 1, it is observed that the pesticide formulation 1 according to the present invention comprises
an active ingredient 2,
at least one substrate 3 of mineral origin and
at least one biopolymer coating 4

wherein the active ingredient 2 is adsorbed on the surface of the substrate 3 and the biopolymer coating 4 covers the substrate 3 onto which the active ingredient 2 is adsorbed.

Preferably, the active ingredient 2 has a solubility in water ranging between 100 mg/L and 500 g/L, more preferably has a solubility in water between 1 and 50 g/L, and has a volatility ranging between 10 mg/L and 3,000 mg/L, more preferably has a volatility between 500 and 1,500 mg/L.

According to the preferred embodiment of the present invention, the active ingredient 2 is a compound having herbicide action. More preferably, the active ingredient 2 is dicamba and/or salts thereof.

Preferably, the substrate 3 is a nanostructured substrate, a microstructured substrate or a mixture thereof.

Preferably the substrate 3 is selected from the family of clays, more preferably is montmorillonite.

The Inventors considered different types of clays, among which bentonite, zeolite and montmorillonite; all the materials allowed to achieve the object of the present invention.

The materials were used without any pretreatment.

Preferably, the substrate 3 has dimensions ranging between 5 nm and 10 μm, more preferably it has dimensions between 50 nm and 2 μm.

Preferably, the coating 4 is selected from the family of degradable biopolymers, more preferably is selected from the biodegradable polysaccharides, even more preferably is guar gum or carboxymethylcellulose.

Preferably, the active ingredient 2 is adsorbed on the surface of the substrate 3, with respect to the total amount of the pesticide formulation 1, in an amount ranging between 0.1% by weight and 90% by weight, more preferably in an amount of 30% by weight.

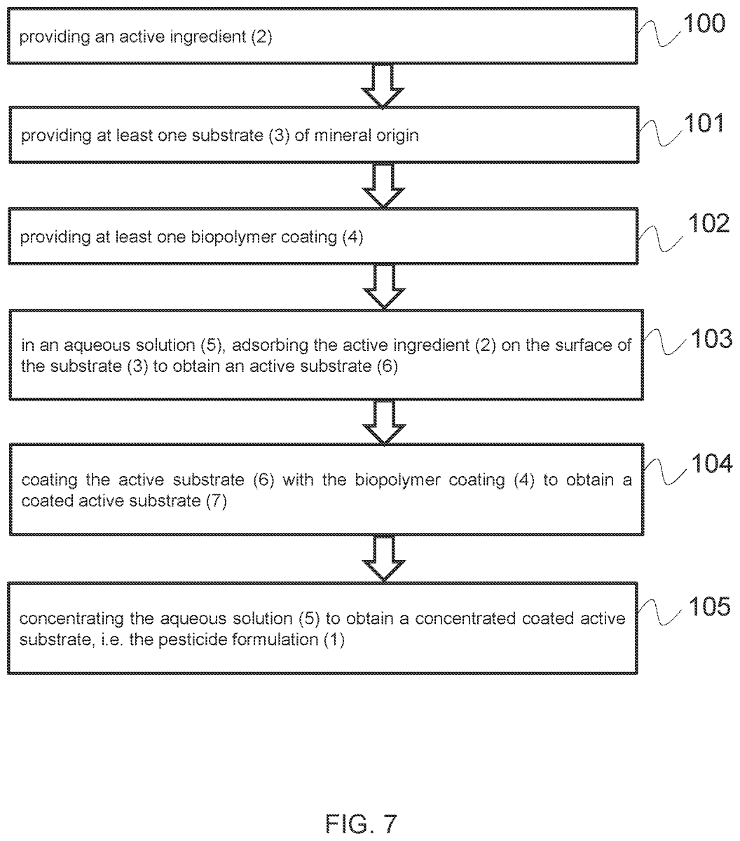

With reference to FIG. 7, a method for the production of a pesticide formulation 1 forms, moreover, an aspect independent and usable autonomously with respect to the other aspects of the invention, which method comprises the following steps:
providing an active ingredient 2 (step 100);
providing a substrate 3 of mineral origin (step 101);
providing a biopolymer coating 4 (step 102);
in an aqueous solution 5, adsorbing the active ingredient 2 on the surface of the substrate 3 to obtain an active substrate 6 (step 103);
coating the active substrate 6 with the biopolymer coating 4 to obtain a coated active substrate 7 (step (104);
concentrating the aqueous solution 5 to concentrate the coated active substrate 7 (step 105).

The active ingredient 2 can be dissolved in the aqueous solution 5 before adding the substrate 3 or simultaneously with the substrate 3 or after the substrate 3, depending on need.

The active ingredient 2 is dissolved in the aqueous solution 5 before adding the substrate 3 when the dissolution kinetics of the active ingredient is low; instead, the active ingredient 2 is dissolved in the aqueous solution 5 simultaneously or subsequently to the substrate 3 when the dissolution kinetics is high and when needs such as the high solubility of the active ingredient arise.

Preferably, the adsorption, coating and concentration steps of the method for the production of the pesticide formulation 1 occur in conditions of ambient pressure and temperature.

The incorporation method of the active ingredient 2, described above and identified as adsorption from solution, is very simple, fast, cheap and does not require complex or expensive instruments.

It is to be noted that adsorption is responsible for the reduction of solubility and volatility of the active ingredient, while the coating emphasizes and maximizes these effects.

A method for the control of weeds by means of a pesticide formulation 1, in which the active ingredient 2 is an herbicide, forms, moreover, an aspect independent and usable autonomously with respect to the other aspects of the invention, which method comprises the following steps:
providing a pesticide formulation 1 as above described, in which the active ingredient 2 is an herbicide (step 200);
under conditions of ambient pressure and temperature, applying the herbicide formulation on weeds or soil in the areas where their growth is to be prevented (step 201).

Preferably, the pesticide formulation 1 is applied as such on weeds or soil in the areas where their growth is to be prevented.

Optionally, the method for the control of weeds according to the present invention can further comprise, between steps 200 and 201, the step of
providing a diluent 9;
diluting the pesticide formulation 1 with the diluent 9 in a ratio ranging between 0.1 mg/g and 100 mg/g, preferably in a ratio between 7 mg/g and 30 mg/g, more preferably in a ratio of 20 mg/g.

In case the aforesaid optional method is employed, the pesticide formulation 1 is applied diluted in the diluent 9 on weeds or soil in the areas where their growth is to be prevented.

Preferably, the diluent 9 is water or a mixture of water and adjuvant substances (for example canola oil, used as a wetting agent, at a concentration in the diluent 9 preferably ranging between 1 and 12 g L).

The formulations and the methods above described are preferably applicable in agricultural areas, pasture areas, uncultivated areas and non-agricultural areas.

The present invention appears to be characterized by the ability, by the substrate, specifically by the clay, to adsorb the active ingredient and, then, to bind the molecule to the surface of the substrate, resulting in a reduction of the overall herbicide dose.

Unlike the commercial products incorporating the same active ingredient, which provide to insert excipients stabilizing the solution (in low percentages), the formulation of the present invention provides to use the clay not as an adjuvant but as a physical support for the active ingredient.

The present invention does not use substances for surface modification by replacing functional groups or hooking chains to the surface (“grafting”) of the surface or substances performing the function of increasing the compatibility between the active ingredient and the support surface (“linkers”), but it is based on a simple and biocompatible system, in order to have an almost zero environmental impact and a greater control of the variables that can affect the release (pH, thickness of the coating film, size of the granules, temperature).

On the contrary, the commercial formulations exhibit, besides the aforesaid factors, even other ones such as adjuvants concentration, process temperature, research of the best proportions, etcetera.

Moreover, the present invention, thanks to the realisation easiness of the incorporation and coating process, does not require the employ of expensive and wasteful instruments, also from an energy point of view and this is an additional advantage compared to the known solutions that, instead, involve a greater energy expenditure and more expensive equipments, such as for example thermostatic baths, tubular muffle ovens, extruders, and so on.

According to the present invention, with minimum investments, mainly at the level of raw materials, it is possible to realize a complete and very effective system, characterized by a very high potential as to the release mode of the active ingredient, both in terms of kinetics and amount.

The present invention is hereinafter described in detail by means of experimental data, which are to be intended as illustrative but non-limiting of the present invention.

The following tests were carried out on various synthesized formulations according to the present invention:
batch release test to simulate the dilution effect of the formulation on field, before the final application; the tests were carried out using 50 mL of deionized water in which the formulation according to the invention was diluted; the analysis was performed with the help of a UV-VIS spectrophotometer, with a sampling of the release solution at hourly intervals;
FTIR (Fourier Transform InfraRed Spectroscopy) analysis to evaluate the bond typology between the active ingredient, specifically dicamba, and the substrate surface, specifically clay, and to consequently verify the possible volatilization of the adsorbed active ingredient;
transport test in column to evaluate the mobility of the new formulation in a porous medium simulating the subsoil;
volatility test of the active ingredient.

For the experimental tests, a glass beaker containing 50 mL of dicamba solution in deionized water at a known concentration C₀ (the best results were obtained with C₀ equal to 7 g/L) has been used, inside which 1 g of clay has been added; magnetic stirring at ambient temperature for a time ranging between 2 and 24 hours was carried out.

At the end of this process, the solution was placed inside a centrifuge and was centrifuged in order to separate the solid impregnated with herbicide.

The supernatant portion was analysed in order to quantify the percentage of herbicide adsorbed on the support surface.

The tests were carried out without pH adjustment, which for a dicamba solution is acidic and approximately equal to 2; at these pH values the solubility of the dicamba in water is close to 8 g/L, the maximum concentration for which the tests hereinafter presented have been carried out.

Since the dicamba solubility considerably increases (>250 g/L) for pH values higher than 4.1, loadings at significantly higher concentrations will be necessary with basified solutions.

Detail of the Laboratory Synthesis Procedure

1 gram of clay (bentonite or zeolite or montmorillonite) is placed inside a beaker containing deionized water; dicamba (3,6-dichloro-2-methoxybenzoic acid) is added to the suspension. The solution is then stirred for a time ranging between 2 and 24 hours at ambient temperature and pressure.

At the end of this period of time, the solution is transferred to a centrifuge and it is centrifuged in order to separate the solid part (clay impregnated with dicamba) from the liquid part; the operating conditions of the treatment are 3,950 rpm for 30 minutes.

Subsequently, the supernatant derived from this operation is analysed using a spectrophotometer to determine the residual concentration of dicamba present in the same supernatant.

Since the volume of the supernatant is known, the mass amount of dicamba left in solution is obtained and, by difference with respect to the amount initially inserted, the grams adsorbed on the clay are obtained.

The solid part is used to carry out the release test, i.e. by inserting the dicamba-loaded clay in 50 mL of deionized water.

The sampling is performed every hour and the withdrawn solution is filtered with a PTFE syringe filter, in order to remove the clay part that can create problems during the analysis; the corresponding withdrawn amount in mL of solution is reintegrated with the same amount in mL of deionized water.

It is important to underline how the supernatant part, used to quantify the mass of dicamba adsorbed on the clay, can be reused as an impregnating solution for following incorporations (“drug loading”), thus avoiding unnecessary waste of active ingredient.

Since the amount of dicamba still present in solution is known, it is possible to reintegrate the fraction that has been adsorbed so as to return to the initial concentration of herbicide solution with which to put the clays in contact and subsequently to perform a new adsorption.

The process is repeatable an indefinite number of times and the degree of use of the active ingredient is therefore very high.

Results

Adsorption Test—Montmorillonite K10

Various tests have been carried out on four types of clays, which differ in the different content of impurities, morphological microstructure (lamellar, channeled, etcetera).

In FIG. 2 the results of the montmorillonite K10 are reported.

To quantify the mass of active ingredient adsorbed onto a substrate it is possible to use two parameters: the Encapsulation Efficiency and the Loading Capacity. The Encapsulation Efficiency (EE %) expresses the amount of active ingredient (commonly denoted as “active ingredient”, hereinafter referred to as AI) incorporated on the material with respect to the quantity inserted in the solution in contact with the substrate and it is expressed by using the formula:

$$EE ( \% ) = [ ( {W}_{0} - {W}_{free} ) / {W}_{0} ] \cdot 100 [ g / g ]$$

where W₀ is the mass of initial active ingredient (completely dissolved in water) and W_{free} is the mass of active ingredient still dissolved in solution at the end of the loading process. The difference W₀−W_{free} represents the amount of herbicide adsorbed on the substrate, W_{ads}.

The Loading Capacity (LC %) expresses the ratio between the mass of AI adsorbed on the substrate and the mass of the substrate itself:

$$LC ( \% ) = [ ( {W}_{0} - {W}_{free} ) / {W}_{sub} ] \cdot 100 [ g / g ]$$

where W_{sub} is the mass of substrate (clay).

The graph of FIG. 2 shows the two above-mentioned parameters as a function of the initial concentration C₀ of the dicamba solution with which clay is placed in contact.

Different values of initial concentration of dicamba were tested in order to optimize the herbicide incorporation process.

It is to be noted how both parameters increase as a function of C₀ and that, in particular, the values of EE % and LC % achieved by the montmorillonite K10—dicamba system amount to 24% and 9% respectively.

Release Test—Montmorillonite K10

The release tests aim at evaluating the behaviour of the formulation according to the present invention once diluted in water, so as to simulate what happens in actual conditions when the product is diluted in water before the application on field.

The tests were carried out in batches, evaluating three different formulations of the montmorillonite K10—dicamba system: a first formulation without coating, a second formulation with coating of guar gum (GG) and a third formulation with coating of carboxymethylcellulose (CMC).

The application of the coating is carried out by following the solution adsorption process: the sample is placed inside a sonicator for 5 minutes, so as to avoid the formation of aggregates; subsequently the polysaccharide is inserted and the system is stirred for two hours.

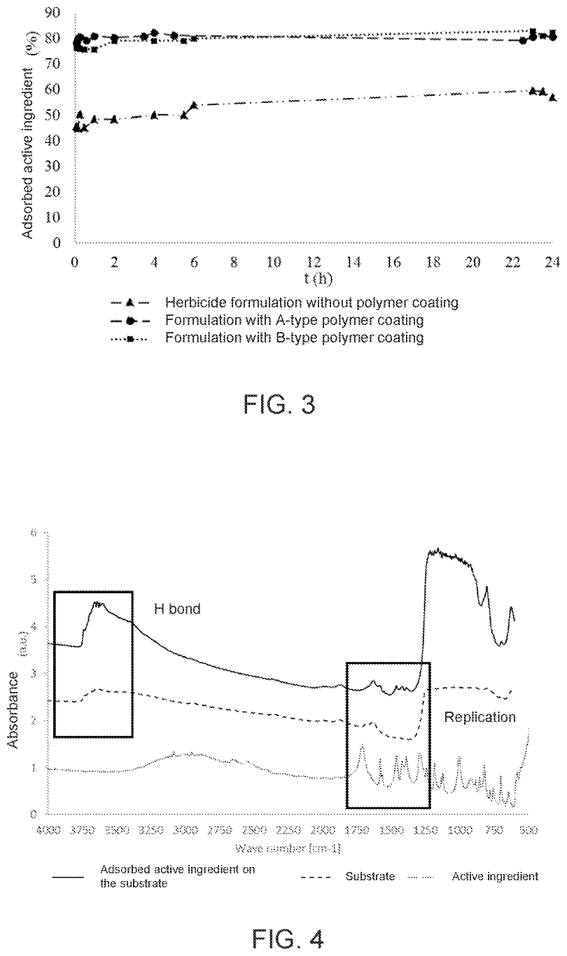

The two systems were then analysed from the release viewpoint and in FIG. 3 they are compared with the original system.

FIG. 3 shows the cumulative curve over time of the percentage of dicamba left adsorbed on the nanostructured material. This percentage is calculated as the ratio between the amount of herbicide present in water and that incorporated at the end of the adsorption process [g/g](corresponding for this test at time t=0).

The graph shows how the amount of herbicide released quickly stabilizes on a constant value over time (50% of the incorporated dicamba is released in the first 30 minutes, followed by a slower release “kinetics”). Moreover, the overall released percentage can be modulated in relation to the type of coating applied to the particles. It is highlighted, therefore, how the application of the coating can modulate only the amount of released herbicide, but it neither hinder nor facilitate the release kinetics of dicamba.

This can have a great effect for the practical application of the present invention, since it is possible to produce different types of formulations releasing a predetermined amount of herbicide in relation to the type of the chosen coating, which limits the herbicide release (contrary to the case of pure clay where it is sufficient desorption of the molecules from the clay surface) due to an additional diffusion phase from the substrate surface towards outside.

FTIR (Fourier Transform InfraRed Spectroscopy)

The nature of the bond that is established between adsorbed herbicide molecules and the surface of the adsorbent particle has been investigated in detail with FTIR spectroscopic investigations. In FIG. 4 a comparison between the infrared spectra of the dicamba (active ingredient), of the montmorillonite K10 used as a substrate and of the clay—dicamba system (active substrate) is reported.

The infrared spectroscopy is a technique that allows to identify the type of chemical species and of the functional groups present on the sample surface; the wavenumber allows to understand at what frequency a bond vibrates and consequently to recognize it on the basis of a masses and forces balance, just like it was an harmonic oscillator.

In the case under examination, it is important to know two very simple principles to understand the graph:
in case an intensity increase of a specific band occurs, it is possible that a reversible interaction between an atom or a functional group present on the surface, to which interaction the aforesaid band refers, as well as an adsorbed species were formed. In particular, if it is a band relevant to a hydrogen bond, it is possible that an H bond between the adsorbed species and the material surface was formed;
if, by comparison with the material as such, the presence of new bands is observed, it is possible that a new physisorbed or chemisorbed chemical species is present on the same material surface.

Therefore, from experimental evidences it can be observed how on the formulation spectrum (continue curve of FIG. 4) the herbicide vibrational modes replicate (dotted curve, below in the graph) in areas at low wavenumbers, as highlighted. Moreover, it has to be highlighted that the test is carried out in high vacuum conditions (0.001 Pa). The presence of the herbicide characteristic bands on the support means not only an occurred incorporation, but also a volatility reduction of dicamba, which turns out to be well adsorbed on the clay surface, despite the pressure conditions previously illustrated.

The further confirmation of the fact that the active ingredient is effectively adsorbed on the surface and, then, not present in a simple mechanical mixture with the support, is highlighted by the rectangle at high wavenumbers, which highlights an intensity increase of the band relevant to the silanols with respect to the material as such. This is an indication of an interaction through formation of H bonds between the active ingredient and the substrate surface.

This—very important—datum highlights the achievement of the first object proposed by the present invention, namely to reduce the volatilization of the active ingredient.

Since the aforesaid test refers to the clay—herbicide without any coating system, it is deemed that the presence of a polysaccharide that totally encloses the montmorillonite granule after the dicamba loading could surely prevent a further volatilization of the active ingredient compared to the system without presence of the biocompatible film.

Tests in Column

Transport tests in saturated porous medium were carried out to simulate groundwater transport. Through this type of tests, it is possible to evaluate how a certain substance moves inside a porous medium by monitoring the output concentration from the column, by expressing it as normalized concentration compared to the injected initial one (C/C₀ ratio). The concentration of introduced particles is equal to 0.9 g/L in the presence of a salt concentration equal to 30 mM NaCl.

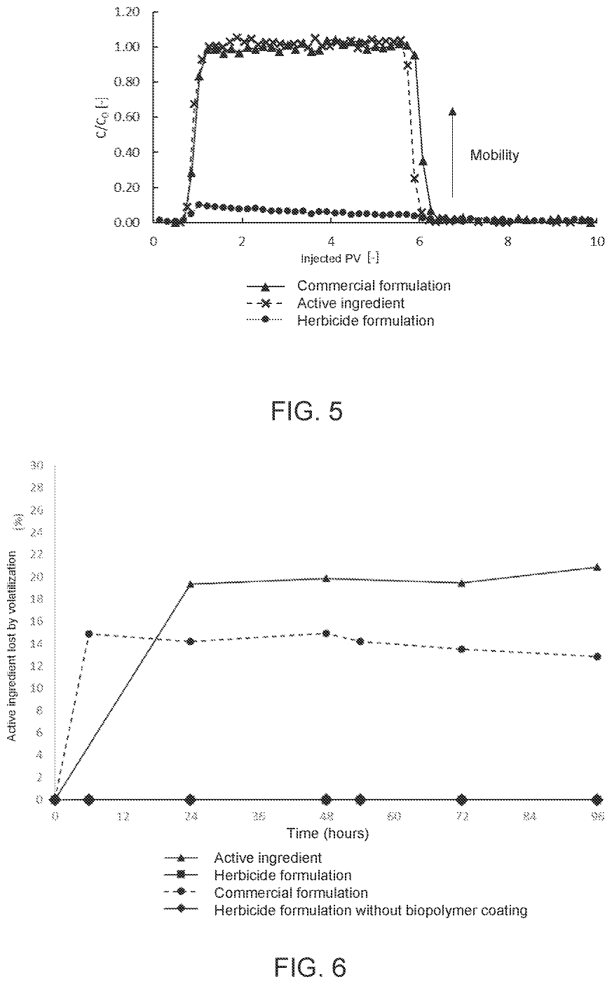

It has been observed that the formulation according to the present invention is much less mobile than the commercial counterpart and than the sole active ingredient, as illustrated in FIG. 5.

The graph of FIG. 5 expresses how the C/C₀ ratio, i.e. the ratio between the concentration C of the formulation (and, in general of any species “x”) exiting the column and the initial concentration C₀ of the same, varies as a function of time.

A very great ratio reduction is highlighted in the case of the formulation according to the invention, exhibiting a mobility decrease of about 95%; this proves the achievement of the second object of the invention, namely the mobility reduction in the subsoil.

Overall, the formulation of the present invention is based on the employ of biodegradable and environmentally friendly of natural origin materials used as a substrate for the dicamba dispersion control in the environment.

The use of such supports makes this active ingredient less volatile (thereby resulting in a lower risk for the operator, a lower herbicide loss, a lower risk of damages to the adjacent crops), less mobile and less soluble (reducing leaching), which also implies a possible significant reduction of dosage required today for an effective application on field.

Once produced, the formulation can be dispersed in an aqueous medium and applied by using common spraying equipment employed for the application of plant protection products.

The applicability of this system is not limited to the sole dicamba, but in general line it can promote the incorporation of several agrochemical active ingredients, such as fertilizers, fungicides, insecticides, acaricides, etcetera that suffer from high volatility and or solubility.

A potential social and environmental impact comes from here, such as the reduction of the effects of the agricultural activity on the environment and a lower risk for the workers' health, as well as an economic impact (taking into account that some competing active ingredients are at risk of prohibition in the European Community in the next years).

Volatility Test of the Active Ingredient

Since there are not UNI, ISO or of other nature regulations, in order to determine the herbicide volatility tests were carried out by using simple laboratory instruments (weighing scales, stirrer and various glassware). The procedure involved the use of three solutions:
Solution A: formulation of the following patent suspended in 200 mL of deionized water;
Solution B: pure dicamba active ingredient, dissolved in 200 mL of deionized water;
Solution C: 200 mL of deionized water.

All the previous solutions were stirred without lids, caps or parafilm that would hinder the evaporation. The characterization took place by sampling the solutions every 24 hours and analysing them with a spectrophotometer. The withdrawn amount was replenished with deionized water.

Some specifications:
the clay suspended in solution A has an active ingredient content by weight of approximately 92 mg;
in order to make a comparison, and therefore to evaluate whether the formulation actually makes the dicamba less volatile, the amount by weight of the active ingredient inserted in solution B is identical to that adsorbed on the clay, that is 92 mg;
the weighing of the solutions, to evaluate the amount of evaporated substance, also includes the contribution of water. The presence of solution C is therefore necessary, since it is the mass to be subtracted, point by point every 24 hours, to isolate the contribution of the active ingredient evaporated from each solution;
all the solutions were stirred at 300 rpm, in order to guarantee the same operating conditions;
the test ends upon complete evaporation of the solutions.

In FIG. 6 the reduction of the active ingredient by volatilization can be observe, which reduction is expressed as the amount of lost dicamba normalized to the amount of the same inserted at time zero, as a function of time.

In the case of K10—Dicamba system has emerged how the concentration of active ingredient in solution remains constant throughout the duration of the test, this denoting that the clay fulfils the function of anchoring the active ingredient preventing the volatilization thereof. On the other hand, the sole active ingredient (solution B) is subject to an initial rapid volatilization and to a subsequent slow and progressive loss in mass of the active ingredient.

Therefore, the test is configured as a further confirmation of the reduced volatility of the dicamba active ingredient when using clay as a carrier, guaranteeing this property even for long periods of time.

As can be deduced from what above exposed, the innovative technical solution herein described has the following advantageous features:
allows to reduce the volatilization of the active ingredient
allows to reduce the mobility of the active ingredient in a porous medium
the formulation can be produced using low cost materials, in simple operating conditions (ambient pressure and temperature), quickly and with a low energy cost.

From the description hereinabove reported it is evident, therefore, how the present invention allows to achieve the proposed objects.

It is equally evident, to a person skilled in the art, that it is possible to make modifications and further variations to the solution described with reference to the attached figures, without thereby departing from the teaching of the present invention and from the scope as defined in the appended claims.

What is claimed is:

1. A pesticide formulation comprising
an active ingredient,
at least one substrate of a mineral origin and
at least one biopolymer coating,
wherein the active ingredient is adsorbed on a surface of the at least one substrate and the biopolymer coating covers the at least one substrate.

2. The pesticide formulation according to claim 1, wherein the active ingredient has a solubility in water ranging between 100 mg/L and 500 g/L, or has a solubility in water ranging between 1 and 50 g/L.

3. The pesticide formulation according to claim 2, wherein the active ingredient is an herbicide.

4. The pesticide formulation according to claim 3, wherein the active ingredient is a dicamba and/or salts of the dicamba.

5. The pesticide formulation according to claim 1, wherein the at least one substrate is a nanostructured substrate, a microstructured substrate or a mixture of the nanostructured substrate and the microstructured substrate.

6. The pesticide formulation according to claim 5, wherein the at least one substrate is selected from a family of clays, and the at least one substrate is a montmorillonite.

7. The pesticide formulation according to claim 6, wherein the at least one substrate has dimensions ranging between 5 nm and 10 μm, or the at least one substrate has dimensions ranging between 50 nm and 2 μm.

8. The pesticide formulation according to claim 1, wherein the at least one biopolymer coating is selected from a family of degradable biopolymers, or the at least one biopolymer coating is selected from biodegradable polysaccharides, or the at least one biopolymer coating is a guar gum or a carboxymethylcellulose.

9. The pesticide formulation according to claim 1, wherein with respect to a total amount of the pesticide formulation, the active ingredient is in an amount ranging between 0.1% by weight and 90% by weight, or in an amount of 30% by weight.

10. The pesticide formulation according to claim 1, wherein the pesticide formulation is used for a control of weeds in agricultural areas, pasture areas, uncultivated areas and extra-agricultural areas.

11. A method for a production of a pesticide formulation comprising the following steps:
step 100: providing an active ingredient;
step 101: providing at least one substrate of a mineral origin;
step 102: providing at least one biopolymer coating;
step 103: in an aqueous solution, adsorbing the active ingredient on a surface of the at least one substrate to obtain an active substrate;
step 104: coating the active substrate with the at least one biopolymer coating to obtain a coated active substrate;
step 105: concentrating the aqueous solution to obtain a concentrated coated active substrate, wherein the concentrated coated active substrate is the pesticide formulation.

12. The method according to claim 11, wherein the active ingredient is an herbicide.

13. The method according to claim 12, wherein the active ingredient is dicamba and/or salts of the dicamba.

14. The method according to claim 13, wherein the active ingredient is dissolved in the aqueous solution before adding the at least one substrate.

15. The method according to claim 13, wherein the active ingredient is dissolved in the aqueous solution simultaneously with an addition of the at least one substrate.

16. The method according to claim 13, wherein the active ingredient is dissolved in the aqueous solution after the addition of the at least one substrate.

17. The method according to claim 16, wherein adsorption, coating and concentration steps occur in conditions of an ambient pressure and temperature.

18. A method for a control of weeds by using the pesticide formulation, according to claim 1, comprising the following steps:
step 200: providing the pesticide formulation;
step 201: under conditions of an ambient pressure and temperature, applying the pesticide formulation on the weeds or a soil in areas where a growth of the weeds is to be prevented.

19. The method according to claim 18, wherein the pesticide formulation is applied on the weeds or the soil in the areas where the growth of the weeds is to be prevented.

20. The method according to claim 19, further comprising, between steps 200 and 201, the step of
providing a diluent;
diluting the pesticide formulation with the diluent in a ratio ranging between 0.1 mg/g and 100 mg/g, or in a ratio ranging between 7 mg/g and 30 mg/g, or in a ratio of 20 mg/g.

21. The method according to claim 20, wherein the pesticide formulation is diluted in the diluent and applied on the weeds or the soil in the areas where the growth of the weeds is to be prevented.

22. The method according to claim 21, wherein the diluent is a water or a mixture of the water and an adjuvant, or the diluent is a canola oil.

23. The method according to 22, wherein the method is used in agricultural areas, pasture areas, uncultivated areas and non-agricultural areas.
